(19) United States
(12) Patent Application Publication
(10) Pub. No.: US 2009/0150261 A1
(43) Pub. Date: Jun. 11, 2009

(54) Method and apparatus for providing status of inventory

(76) Inventor: Allen Lee Hogan, York, PA (US)

Correspondence Address: MCNEES WALLACE & NURICK LLC, 100 PINE STREET, P.O. BOX 1166, HARRISBURG, PA, 17108-1166, US

(21) Appl. No.: 12/315,711

(22) Filed: Dec. 5, 2008

Related U.S. Application Data
(60) Provisional application No. 61/007,013, filed on Dec. 8, 2007.

(51) Int. Cl. G06Q 30/00

(52) U.S. Cl. 705/27

(57) ABSTRACT

A stateless e-commerce status indication system is provided. The system includes software code executable on at least one host website. The software code communicates with a remote processing server to obtain status information relating to status of an item for sale. The software then communicates at least a portion of the status information to a user of the host website.

This is a utility application claiming the benefit, under 35 U.S.C. § 19(e), of U.S. provisional application No. 61/007,013 filed on Dec. 8, 2007 and entitled APPARATUS AND METHOD FOR COMMUNICATING THE STATUS OF AN ITEM FOR SALE, the entirety of which is incorporated herein by reference.

### FIELD OF THE INVENTION

The present invention relates to the field of Internet sales and, in particular, the communication of status information over the Internet.

### BACKGROUND OF THE INVENTION

It is believed that prior art methods and apparatuses of Internet sales and inventory tracking systems permit the status of an item for sale (e.g., whether the item has been sold or not) to be communicated to potential buyers only via the website (or domain) listing the item for sale. For example, an item for sale on Ebay may be listed on Ebay's website as “sold out” if the item has already been sold or is otherwise no longer available. If the item for sale is advertised on a domain different than the one listing the item for sale, a potential buyer visiting the different domain may not know whether the advertised item is still available for sale on the listing website, nor could the seller prevent a sale of a “sold out” item on the different domain, unless the status of the item on the different domain is updated manually or in a non-simultaneous fashion. This process becomes very difficult if the item is advertised on numerous different domains.

Referring to FIG. 1, there is illustrated a prior art method 100 for advertising a sale of an item across multiple domains. A seller advertises an item for sale on three websites 101, 105, 110 (e.g., Myspace, Craig's list and a Blogger page). A first buyer 145 visits website 101 and purchases the item by clicking on, for example, a “Buy” button/graphic 130, upon which website 101 notifies buyer 145 of the sale via a sale banner 115. The item is then shipped to buyer 145. Before the seller removes the sale advertisement from websites 105 and 110, second and third buyers 150, 155 visit websites 105, 110 to purchase the already sold item. Buyers 150, 155 click on their respective “Buy” buttons/graphics 135, 140 and do not receive respective “sold” notifications 120, 125, even though the item has already been sold to first buyer 145. This would require the seller to notify buyers 150, 155 that their sales were not consummated, which may result in disgruntled and/or unhappy buyers 150, 155.

### SUMMARY OF THE INVENTION

The present invention permits the status of an item for sale to be updated automatically across multiple domains that advertise the item. In this manner, the present invention provides for a stateless electronic e-commerce interface that can be placed on web pages to communicate the status of an item for sale.

In accordance with one embodiment of the present invention, a stateless e-commerce status indication system is provided. The system includes software code executable on at least one host website. The software code communicates with a remote processing server to obtain status information relating to status of an item for sale. The software code then communicates at least a portion of the status information to a user of the host website.

In accordance with another embodiment of the present invention, the software code includes a script executable by a web browser.

In accordance with still another embodiment of the present invention, the status information includes at least one of information relating to availability of the item, information relating to whether the item is still for sale, information relating to whether a sale of the item has expired, a description of the item, a quantity of the item, trust metrics for a seller, and a price of the item.

In accordance with still another embodiment of the present invention, the status information includes information relating to an auction.

In accordance with yet another embodiment of the present invention, the information relating to the auction includes at least one of a reserve price, a bid price, and an expiration date of the auction.

In accordance with still another embodiment of the present invention, the status information is communicated to the user via a graphic.

In accordance with another embodiment of the present invention, the graphic relates to the status information obtained from the remote processing server.

In accordance with yet another embodiment of the present invention, the graphic indicates that the item is unavailable for sale if the item was previously sold.

In accordance with another embodiment of the present invention, the graphic advertises a different product if the item was previously sold.

### BRIEF DESCRIPTION OF THE DRAWINGS

FIG. 1 is an illustration of a prior art method for advertising a sale of an item across multiple domains

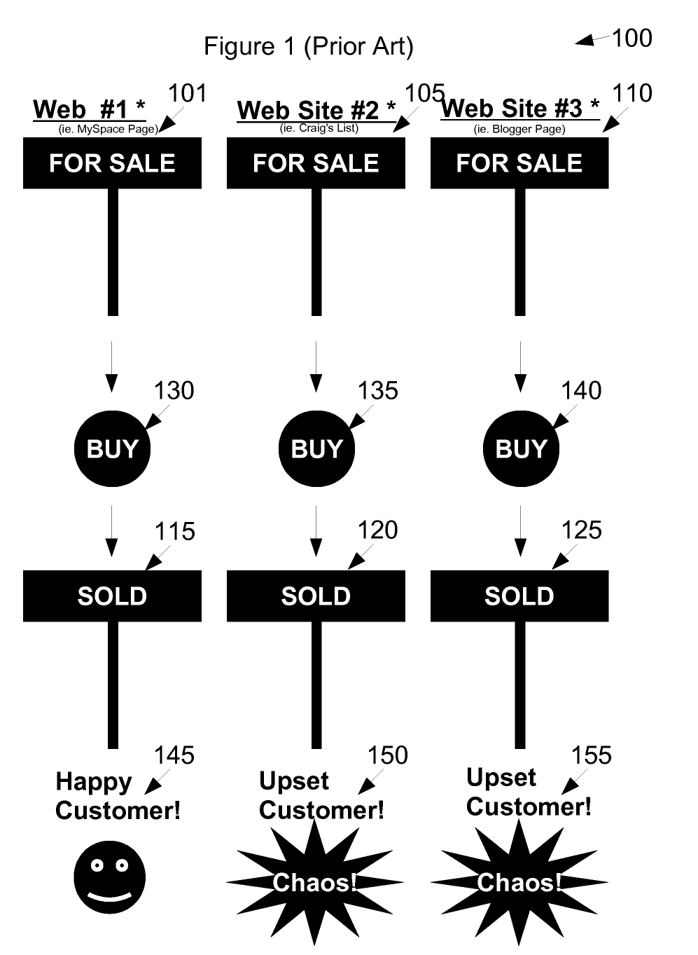

FIG. 2 is an illustration of a first stateless status and inventory control indicator system according to the present invention.

FIG. 3 is a flow diagram depicting a process for updating status information according to the present invention.

FIG. 4 is an illustration of a process for updating status information according to the present invention.

### DETAILED DESCRIPTION

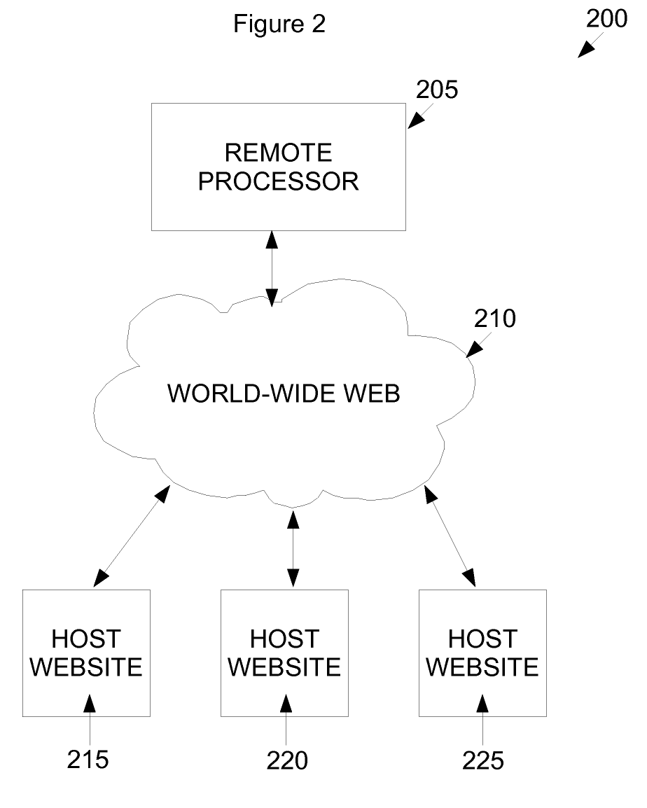

Referring now to FIG. 2, there is seen a first stateless status and inventory control indicator system 200 according to the present invention. Indicator system 200 includes a remote processor 205, a computer network (e.g., the Internet, world wide web, Intranet, etc.) 210 coupled to remote processor 205, and a plurality of host websites 215, 220, and 225 coupled to the computer network 210.

Remote processor 205 is a centralized location, such as a domain/website, that includes all particulars about the status of an item for sale. Such particulars may include, for example, information about the availability of an item, whether the item is still for sale, whether the sale has expired, a description of the item, quantity of the item available, trust metrics for the seller, the price of the item, etc. If the item is for sale at auction, the remote processor 205 may also include, for example, information relating to the auction, such as reserve price, bid price and expiration date of the auction. It will be appreciated by those having ordinary skill in the art that remote processor 205 may be resident at the domain/website listing the item for sale or may be a separate website.

Host websites 215, 220, 225 contain advertisements for the item for sale on the listing domain. In accordance with an example embodiment of the present invention, a programming script (which may be created automatically by remote processor 205 itself) is placed on each of host websites 215, 220, 225 for displaying status information (e.g., a graphic, such as a GIF file or icon) concerning the item for sale. The script permits users' browsers to communicate with remote processor 205 and retrieve therefrom particulars about the item for sale. Based on the information retrieved, the status information is then dynamically updated, e.g., upon each browser refresh, and displayed to the user accordingly. In one embodiment the status information consists of a graphic which may be stored on (and retrieved from) remote processor 205. It should be appreciated, however, that the status information graphic may be created or otherwise embedded within the script itself.

By running the inventive script on host websites 215, 220, 225, the status of the item for sale may be updated automatically and simultaneously to buyers of all websites 215, 220, 225, thereby preventing subsequent buyers from purchasing an unavailable item. The script also permits simultaneous bids across multiple domain names for auctioned items. This permits the seller to offer an item for sale across multiple domains at the same time without the need for manual updating of status information on these domains.

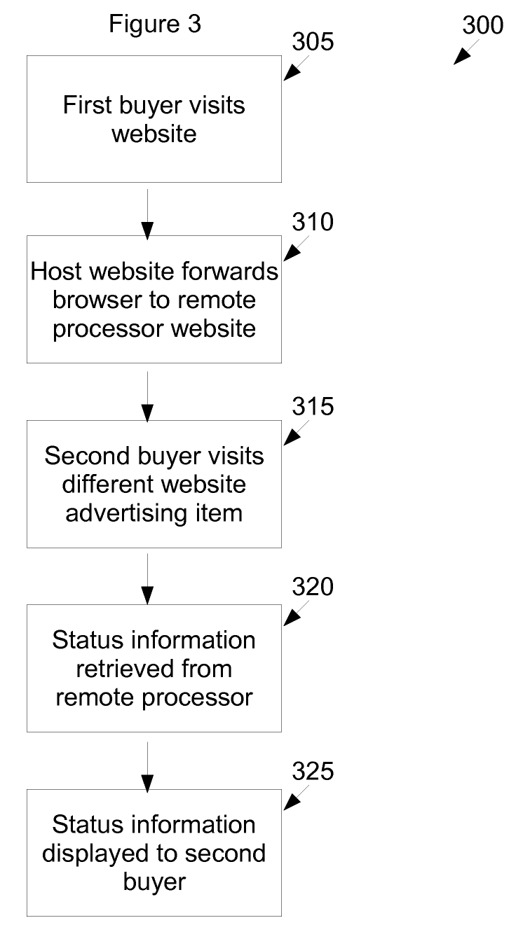

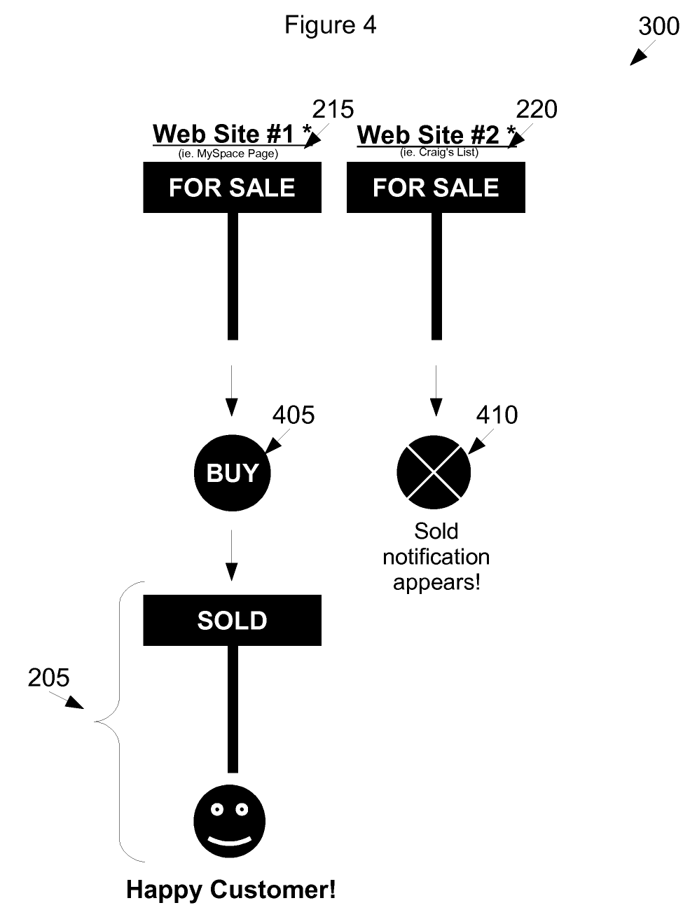

Referring now to FIGS. 3 and 4, there is seen a process 300 for updating status information according to the present invention. At step 305, a first buyer visits website 215, where the script displays a first graphic 405 indicating that the item is for sale. To display the graphic, the script retrieves status information from remote processor 205, which may include, for example, a first graphic 405. At step 310, the host website forwards the user's browser to the website of the remote processor 205, where the sale is consummated. In one embodiment, the seller is automatically notified of the sale by e-mail. At step 315, a second buyer visits website 220. At step 320, the browser of the second buyer interprets the script, which then retrieves the status information from the website of the remote processor 205 and displays it at step 325. Since the item for sale was already sold to the first buyer, the status information retrieved from remote processor 205 indicates that the item was sold, for example, via a second graphic 410. In this manner, the second buyer is notified that the item is no longer for sale immediately upon visiting website 220. In an alternative embodiment, the script causes another item to be advertised on host website 220 if the original item is sold.

What is claimed is:

1. A stateless e-commerce status indication system, the system comprising:
software code executable on at least one host website, the software code communicating with a remote processing server to obtain status information relating to status of an item for sale;
wherein the software code communicates at least a portion of the status information to a user of the host website.

2. The system of claim 1, wherein the software code includes a script executable by a web browser.

3. The system of claim 1, wherein the status information includes at least one of information relating to availability of the item, information relating to whether the item is still for sale, information relating to whether a sale of the item has expired, a description of the item, a quantity of the item, trust metrics for a seller, and a price of the item.

4. The system of claim 1, wherein the status information includes information relating to an auction.

5. The system of claim 4, wherein the information relating to the auction includes at least one of a reserve price, a bid price, and an expiration date of the auction.

6. The system of claim 3, wherein the status information is communicated to the user via a graphic.

7. The system of claim 6, wherein the graphic relates to the status information obtained from the remote processing server.

8. The system of claim 7, wherein the graphic indicates that the item is unavailable for sale if the item was previously sold.

9. The system of claim 7, wherein the graphic indicates that the item is unavailable for sale if a sale time has expired.

10. The system of claim 7, wherein the graphic advertises a different product if the item was previously sold.

11. The system of claim 7, wherein the graphic advertises a different product if a sale time has expired.

12. A method of updating status of an item for sale over the Internet, the method comprising:
running browser script on a host website, the browser script communicating with a remote processing server to obtain status information relating to the status of the item for sale; and
communicating at least a portion of the status information to a user of the host website.

13. The method of claim 12, wherein the status information includes at least one of information relating to availability of the item, information relating to whether the item is still for sale, information relating to whether a sale of the item has expired, a description of the item, a quantity of the item, trust metrics for a seller, and a price of the item.

14. The method of claim 12, wherein the status information includes information relating to an auction.

15. The method of claim 13, wherein the status information communicated to the user includes a graphic.

16. The method of claim 15, wherein the graphic indicates that the item is unavailable for sale if the item was previously sold.

17. The method of claim 15, wherein the graphic indicates that the item is unavailable for sale if a sale time has expired.

18. The method of claim 15, wherein the graphic advertises a different product if the item was previously sold.

19. The method of claim 15, wherein the graphic advertises a different product if a sale time has expired.

20. A stateless e-commerce status indication system, the system comprising:
means for communicating with a remote processing server to obtain status information relating to status of an item for sale; and
means for communicating at least a portion of the status information to a user of the host website.
